(19) United States
(12) Patent Application Publication
(10) Pub. No.: US 2010/0326235 A1
(43) Pub. Date: Dec. 30, 2010

(54) METAL FORGED CRANKSHAFT, APPARATUS FOR METAL FORGING A CRANKSHAFT AND METHOD OF METAL FORGING A CRANKSHAFT

(75) Inventor: Adam D. Kilbon, Cambridgeshire (GB)

Correspondence Address: CATERPILLAR c/o LIELL, MCNEIL & HARPER;Intellectual Property Department, AH9510, 100 N.E. Adams, Peoria, IL, 61629-9510, US

(73) Assignee: PERKINS ENGINES COMPANY LIMITED, Peterborough, GB (GB)

(21) Appl. No.: 12/919,098

(22) PCT Filed: Feb. 29, 2008
(86) PCT No.: PCT/EP2008/052533

§ 371 Date: Aug. 24, 2010

(51) Int. Cl. F16C 3/08; B21J 5/02; B21K 1/08

(52) U.S. Cl. 74/595; 29/6.01; 29/888.08; 72/357

(57) ABSTRACT

An apparatus (30) for metal forging a crankshaft (100) having a plurality of throws (6, 7, 8, 9) having parallel axes (31, 32, 33, 34) comprises an upper die (40) and a lower die (50) each having cavities defining a negative shape of a corresponding half of the crankshaft (100). The two dies (40, 50) have mating surfaces (62, 63, 64, 65) lying on different parallel planes. A metal forged crankshaft (100) forged by such apparatus (30) comprises a plurality of throws (6, 7, 8, 9) having parallel throw axes (31, 32, 33, 34) lying in a same plane of symmetry (41) and split-lines (17, 18, 19, 20) from the forging process lying in planes (42, 43) substantially orthogonal to said plane of symmetry (41).

### RELATION TO OTHER PATENT APPLICATION

This is the U.S. National Stage of PCT/EP2008/052533, filed 29 Feb. 2008.

### TECHNICAL FIELD

This patent disclosure relates generally to combustion engines and, more particularly, to a crankshaft device for use in such combustion engines.

### BACKGROUND

Crankshafts are well known in the industry as devices that can be used in internal combustion engines to transform a reciprocating linear piston movement into a rotational movement. A crankshaft may be assembled from multiple elements or manufactured as a monolithic piece.

Forging, particularly metal forging, is a common method used for manufacturing monolithic crankshafts having high resistance and bearing high fatigue strengths. To forge a crankshaft, a heated piece of a metal, such as a metal rod or billet, may be placed between two forging dies. Each forging die may be provided with a cavity having shape-defining surfaces imprinted with the negative shape of a respective half of the crankshaft. A press acts on the dies pushing them one against the other until respective mating surfaces come into close contact, while the force of the press deforms the metal and the metal fills the cavities formed between the two dies.

Under the high pressure exercised by the press, the metal in excess may leak into the gap between the two forging dies. When the dies are separated, the surface of the crankshaft next to the plane defined by the mating surfaces of the two dies is thus left with burrs, which must be removed by deburring or by a similar post-process.

Even after the burrs have been removed, a visible line, called “split-line” or “flash-line”, extending over the entire length of the crankshaft, may be visible on the crankshaft. The crankshaft area close to the split-line may be weaker than the rest of the crankshaft, because metal impurities may gather in this area during forging, and flaking scales can build up, due to air reaching the metal through the gap between the dies.

The above described conventional method of manufacturing a crankshaft may be applied, for instance, to the prior art four-cylinder crankshaft shown in FIG. 1. In such case, the forging process may be performed by pressing, one against the other, two symmetrically shaped dies having mating surfaces lying in a single flat plane and applying pressure in the directions shown by the arrows in the same FIG. 1. This process may originate a split-line that extends in the central portion of all the side walls of the throws.

Tests have shown that the region of the throws is the area that is subject to the strongest forces during engine operation. Split-lines, which in the present text may indicate portions of the entire split-line, on the throws may limit the maximum strength that can be applied on the throws and, as a consequence, may affect the strength of the whole crankshaft.

On the other hand, engine designers are constantly seeking improvements of the engine, for instance to improve low emission requirements or to provide more power. A route that can be followed includes increasing the engine cylinder pressure, which often means that the whole crankshaft must be redesigned to increase its strength. However, the redesign may include increasing the size of the crankshaft, which then in turn may require a redesign of other engine components, such as the conrod and the cylinder block, to accompany the new design. Furthermore, this solution may add undesired weight to the engine.

Attempts have been made to apply metal treatments to increase the stability and fatigue strength in the area of the throws, so as to make the crankshaft capable of bearing higher pressures while avoiding to redesign the crankshaft and/or the engine. For example, a procedure consists in nitriding the throw surfaces. However, this process may be relatively slow and it cannot be applied to certain metals. The costs involved in applying this technique may also make it inefficient when used in mass production.

The current disclosure aims to overcome or alleviate at least some of the abovementioned disadvantages.

### SUMMARY OF THE DISCLOSURE

The disclosure describes, in one aspect, a metal forged crankshaft comprising a plurality of throws having parallel throw axes lying in a same plane of symmetry and split-lines from the forging process lying in planes substantially orthogonal to the plane of symmetry.

In another aspect, the disclosure describes an apparatus for metal forging a crankshaft having a plurality of throws having parallel throw axes, comprising an upper die and a lower die each having cavities corresponding to a negative imprinted shape of a corresponding half of the crankshaft, the two dies having mating surfaces lying on different parallel planes.

Yet in another aspect, the disclosure describes a method of metal forging a crankshaft including a plurality of throws having parallel throw axes, comprising the steps of heating a rod of metal to make the metal substantially deformable; positioning the rod of metal between two dies having mating surfaces lying on different parallel planes and cavities that define pairs of throws in the crankshaft extending in mutually opposite directions; applying forge pressure on the two dies until the respective mating surfaces contact each other.

### BRIEF DESCRIPTION OF THE DRAWINGS

The foregoing and other features and advantages of the present disclosure will be more fully understood from the following description of various embodiments, when read together with the accompanying drawings, in which:

FIG. 1 is a perspective view of a four-cylinder crankshaft according to the prior art;

FIG. 2 is a perspective view of a similar four-cylinder crankshaft according to the present disclosure;

FIG. 3 is a perspective view of a similar four-cylinder crankshaft according to the present disclosure, showing planes of intersection;

FIG. 4 is a schematic drawing of the central portion of the dies according to the disclosure, when the dies in mutual contact;

FIG. 5 is a schematic drawing of the central portion of the dies according to the disclosure, when the dies are in separate position;

FIG. 6 is a perspective view of a lower die according to the present disclosure.

### DETAILED DESCRIPTION

This disclosure generally relates to a metal forged crankshaft and, in one embodiment, to the forging process of a four-cylinder crankshaft having increased strength.

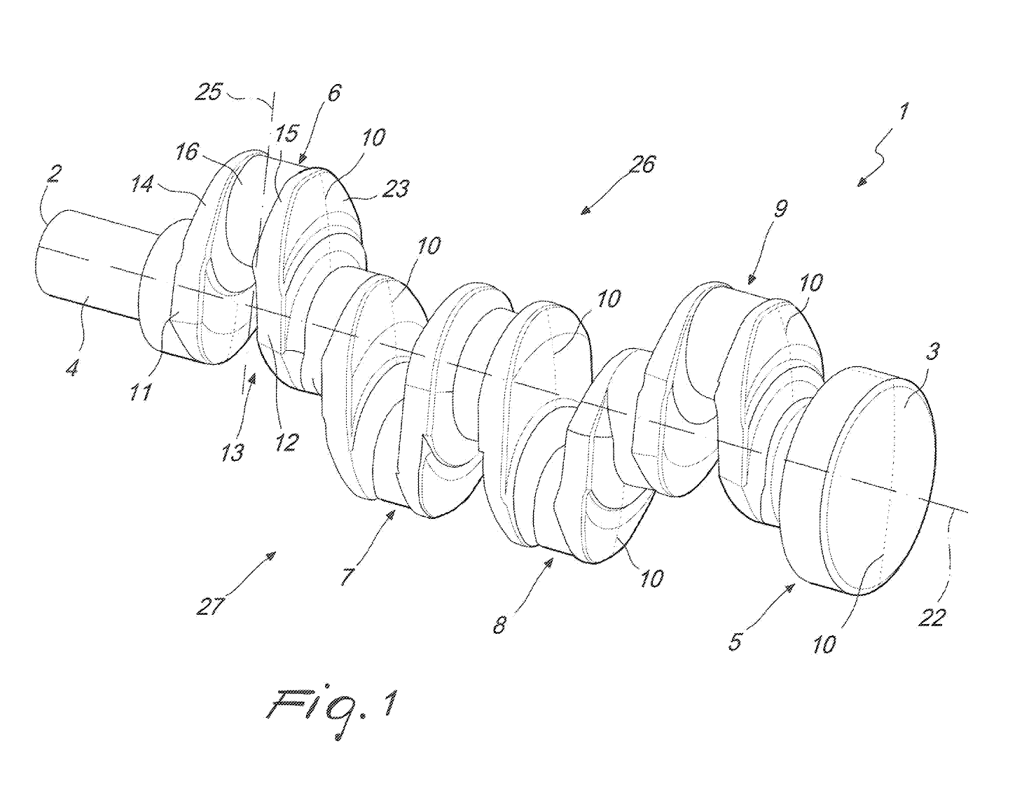

FIG. 1 illustrates a four-cylinder crankshaft 1 as known in the state of the art. The crankshaft may have a first end 2 and a second end 3. At one of its two ends, a cylindrical portion 4 may be formed and, at the opposite end, a round-shaped element 5 may be formed.

Throws, for example first throw 6, second throw 7, third throw 8 and fourth throw 9, may be located in the area extending between the two ends 2 and 3, whose throws may have substantially a same shape. Two of the throws, i.e. outer throws 6 and 9, may be arranged proximate to either end 2, 3 while two throws, i.e. inner throws 7 and 8, may be arranged between the outer throws 6, 9. With respect to the inner throws 5, 6, the outer throws 6, 9 may be arranged in a position rotated by 180 degrees around the longitudinal main axis 22 of the crankshaft 1.

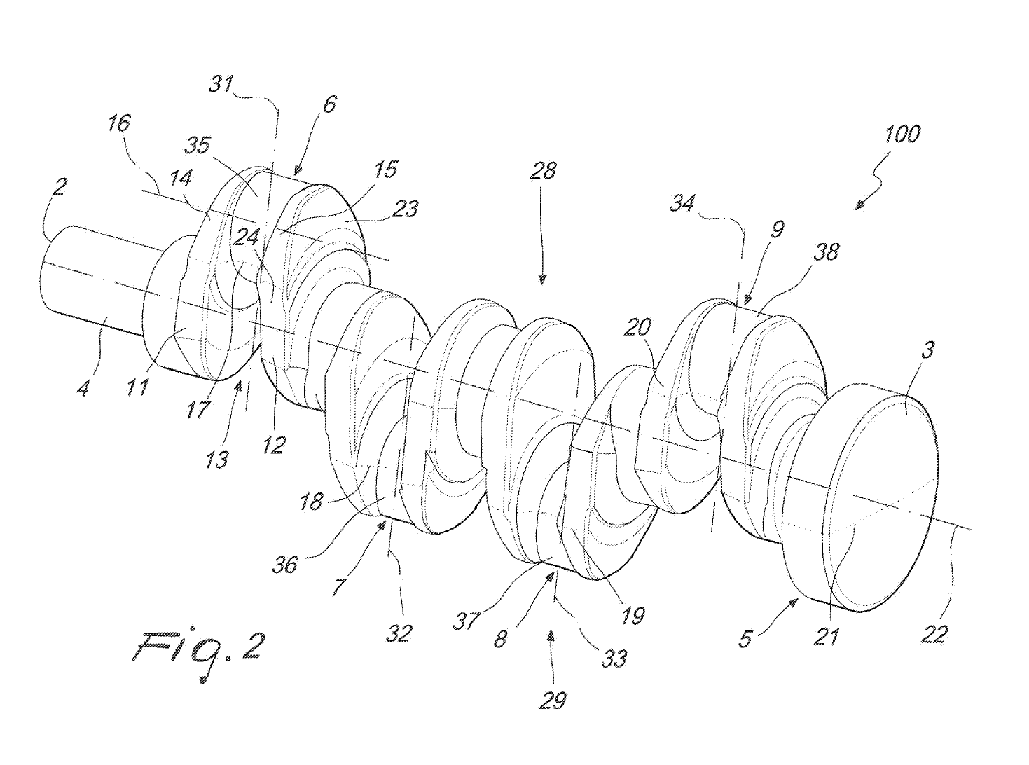

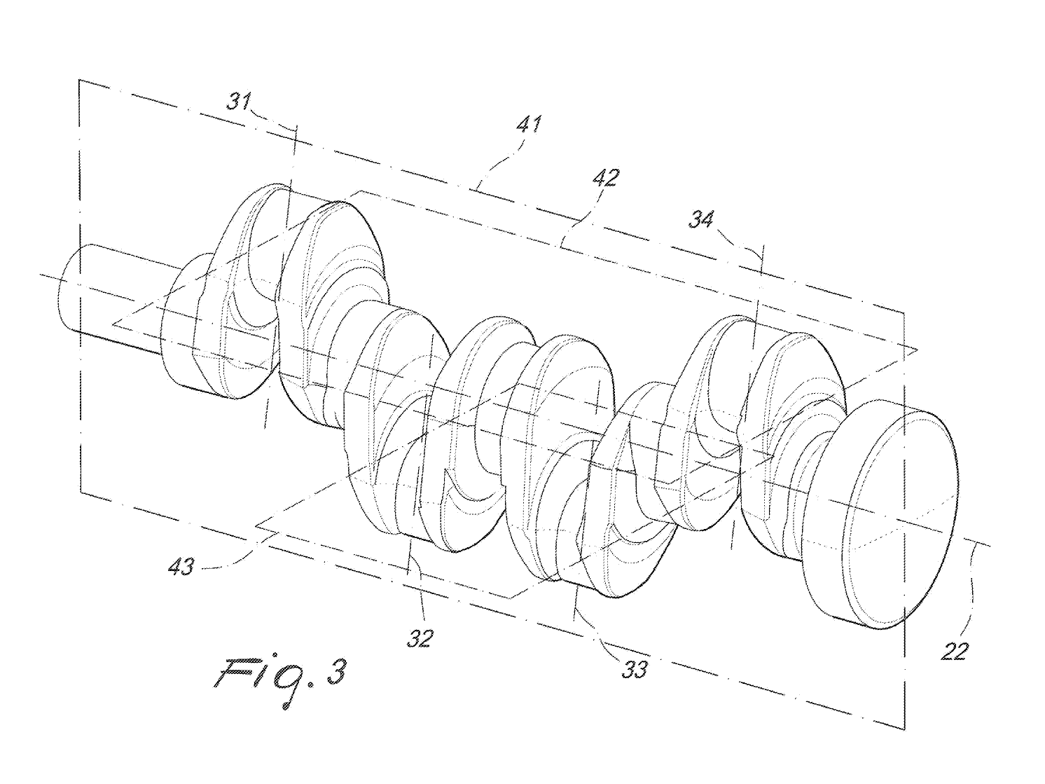

Since each throw 6, 7, 8, 9 may have substantially the same shape, for conciseness, only one throw will now be described in detail. Throw 6 includes a first side element 11 and a second side element 12, both side elements 11, 12, or webs, being spaced from each other and interconnected with a substantially round-shaped member, or pin 35 for engaging with a piston of an engine (not shown in the figure). The side elements 11, 12 may have a shoulder 24 and a throw side wall 23. Additionally, the side elements 11, 12 may have a first reduced cross-sectional or tapered area 14 and a second reduced cross-sectional area 15 in the region where the substantially round-shaped member 35 is interposed. An opening 13 may be formed between the side elements 11, 12 in the region near the crankshaft longitudinal main axis 22. For ease of reference, in this text throw axes 31, 32, 33, 34 are defined for each throw 6, 7, 8, 9 as the axes substantially orthogonal to the longitudinal crankshaft main axis 22 and extending in the centre of each throw from the base to the top of the throw 6, 7, 8, 9, as shown in FIGS. 2 and 3. The base of the throw hereby indicates a proximal portion with respect to the main axis 22 of the crankshaft 100 and top of the throw indicates a distal portion in respect to the main axis 22 of the crankshaft 100.

The crankshaft 1 as shown in FIG. 1 may be manufactured using a conventional two-die forging process, wherein the dies are pressed one against the other along the direction indicated by force direction arrows 26 and 27. This causes split-lines 10 to extend through the entire central area of side walls 23, parallel to the throw axis 31 of the throw, and at the top of the throws, parallel to the longitudinal main axis 22. The split-line 10 may therefore extend substantially all around the throw and may negatively affect the strength of the throw.

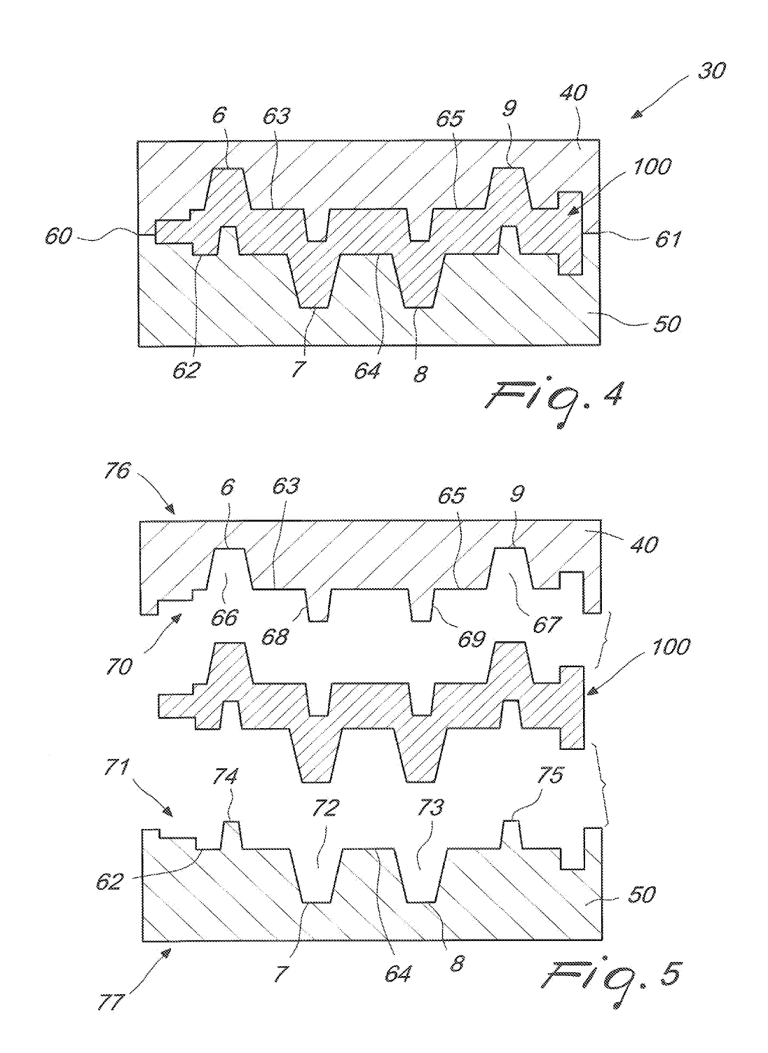

FIGS. 2 and 3 show a crankshaft 100 according to the present disclosure, obtainable by the forging process and forging apparatus which will now be described with reference to FIGS. 4 through 6.

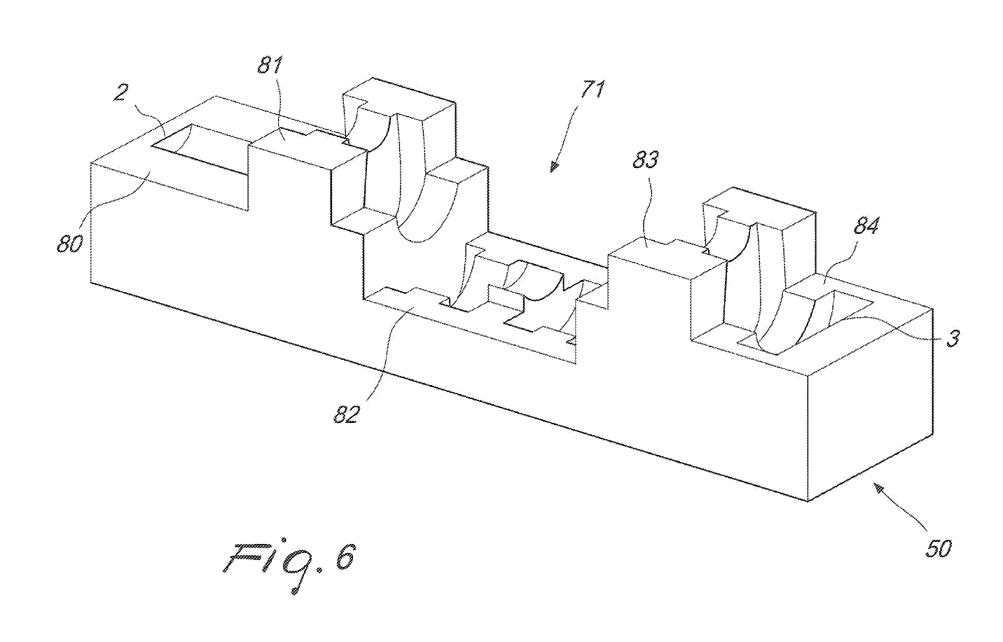

FIGS. 4 and 5 schematically show, in bi-dimensional view, an apparatus 30 comprising an upper die 40 and a lower die 50, each having cavities defining a negative imprinted shape of a corresponding half of crankshaft 100.

Particularly, FIG. 4 shows the central area of two dies 40, 50 in substantially contacted position, while FIG. 5 shows the same two dies 40, 50 separate one from the other.

By way of example, the crankshaft 100 to be forged by the apparatus of FIGS. 4 and 5 may be provided with four throws 6, 7, 8, 9 divided in pairs, the two throws 6, 9 and 7, 8 in each pair extending in mutually opposite directions, as previously described in respect of FIG. 1.

The two dies 40, 50 have mating surfaces 62, 63, 64, 65, which, in the forging process, substantially come into contact with a respective surface, not shown in FIGS. 4 and 5, on the opposite die.

With regard to upper die 40, the cavities and the plurality of shape-defining surfaces thereof may include first 66 and second 67 depressions and first 68 and second 69 protrusions on the inner surface 70 of the die.

The lower die 50 may have similar cavities and shape-defining surfaces, including third 72 and fourth 73 depressions and third 74 and fourth 75 protrusions, substantially corresponding to the complementary shaped depressions 66, 67 and protrusions 68, 69 in the upper die 40.

To better clarify the structure of a die according to the present disclosure, FIG. 6 shows a lower die 50 in a perspective view, highlighting the negative shape of a corresponding half of crankshaft 100 to be manufactured. Particularly, different planes, first plane 80, second plane 81, third plane 82, fourth plane 83 and fifth plane 84 are identified on the inner surface 71 of the die. Such a die may be obtained by conventional techniques, like laser cutting or via a CNC-process.

According to the present disclosure, crankshaft 100 including a plurality of throws 6, 7, 8, 9, said throw having pins 35, 36, 37, 38 is manufactured through metal forging. To this purpose, a rod of metal is heated to make the metal substantially deformable, the rod is positioned between two dies 40, 50 which, as said, have mating surfaces 62, 63, 64, 65 lying on different parallel planes and cavities that define the shape of the crankshaft 100. The metal can be steel, iron or alloys, according to requirements.

As illustrated by force direction arrows 28 and 29 in FIG. 2, pressure is applied in a direction perpendicular to the outer surfaces 76, 77 of the dies 40, 50, illustrated in FIG. 5, and parallel to the main throws axes 31, 32, 33, 34 of the throws 6, 7, 8, 9, until the respective mating surfaces of the dies 40, 50 substantially contact each other.

More in detail, at the points where the outer edges of the dies 40, 50 mate, two channels, a first channel 60 and a second channel 61, may be formed to let the metal in excess flow out. However, during forging of the crankshaft 100, metal may leak into the gap between the two dies while they close one on the other, thus resulting in split-lines, on different planes, when the two dies close one on the other.

The plurality of throws 6, 7, 8, 9 may be mutually parallel and have main throw axes 31, 32, 33, 34 lying in a same plane of symmetry 41. The plane of symmetry 41 may comprise the longitudinal axis 22 of the crankshaft 100 and may be a plane of symmetry of the crankshaft 100. The split-lines 17, 18, 19, 20 from the forging process may all lie in planes 42, 43 substantially orthogonal to the plane of symmetry 41. Pin axis 16 may extend parallel to the longitudinal axis of the crankshaft 100 and may lie in the same plane of symmetry 41.

In one embodiment, the mating surfaces 62, 63, 64, 65 of the dies may meet at positions that are substantially proximate to the base of each throw 6, 7, 8, 9.

As depicted in FIG. 5, when the dies 40, 50 are separated, crankshaft 100 is obtained.

Such crankshaft 100 has a shape that is substantially the same as the shape of crankshaft 1 described with reference to the prior art of FIG. 1. Therefore, those elements having the same function as in the crankshaft of FIG. 1 will be now described using the same reference numbers.

Metal forged crankshaft 100 obtainable by the above described forging process comprises a plurality of throws 6, 7, 8, 9 having parallel throw axes 31, 32, 33, 34 having first, second, third and fourth split-lines 17, 18, 19, 20, while the substantially round-shaped element 5 may have a fifth split-line 21.

As a consequence of the shape of the dies 40, 50 and of the direction of pressure 28, 29 exercised by the press, the split-lines 17, 18, 19, 20 can now extend in a direction that is parallel to the main axis 22 of crankshaft 100 and orthogonal to the throw axes 31, 32, 33, 34 of the throws 6, 7, 8, 9.

In the exemplary crankshaft of FIGS. 2 and 3, split-lines 17, 18 of at least two throws 6, 7, which have pins 35, 36, lie on different planes 42, 43.

More in detail, the plurality of throws 6, 7, 8, 9 comprises two pairs 6, 9 and 7, 8 of throws, wherein the two throws in a pair of throws extend in opposite directions. In each pair of throws 6, 7 and 8, 9, the split-line 17, 19 in a throw 6, 8 lies on a different plane with respect to the split-line 18, 20 of the other throw 7, 9 in the pair.

The split-line 17, 18, 19, 20 in a throw 6, 7, 8, 9 or pin 35, 36, 37, 38 may lie proximate to the base of each throw 6, 7, 8, 9, wherein the base of the throw 6, 7, 8, 9 can be defined as the region near the longitudinal main axis 22 of the crankshaft 100. In this case the strength of the throw 6, 7, 8, 9 and the pin 35, 36, 37, 38 may result to be increased even further.

### INDUSTRIAL APPLICABILITY

This disclosure describes an enhanced metal forged crankshaft, wherein the split-lines have been moved away of the central lateral and top regions of the throws so as to obtain increased strength, which is most valuable in crankshaft where the throws extend parallel one another, particularly in four-cylinder crankshafts. The manufacturing process according to this disclosure achieves increased strength in a crankshaft with no need to change its shape, so that no redesign of parts of the crankshaft or of the motor would be required to meet higher fatigue strength requirements.

The industrial applicability of the crankshaft manufactured using dies as described herein will be readily appreciated from the foregoing discussion.

The present disclosure is applicable to crankshafts for, but not limited to, four-cylinder engines.

It will be appreciated that the foregoing description provides examples of the disclosed system and technique. However, it is contemplated that other implementations of the disclosure may differ in detail from the foregoing examples.

For instance, even though the described examples refer to crankshafts having throws extending in mutually opposite directions, crankshafts having throws all extending in the same directions, for instance for special engines, can be manufactured.

Similarly, it will be appreciated that the mating surfaces of the dies could all lie on different parallel planes, so that each split-line in a throw is located at a different position.

Any references to front and back, left and right, top and bottom, upper and lower, and forward and backward, are intended for convenience of description, not to limit the present invention or its components to any one positional or spacial orientation. For example, it is clear that the lower die and the upper die may be used in a press operating on a horizontal plane with respect to the ground, so that the dies would be at the same level.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein.

Where technical features mentioned in any claim are followed by references signs, the reference signs have been included for the sole purpose of increasing the intelligibility of the claims and accordingly, neither the reference signs nor their absence have any limiting effect on the technical features as described above or on the scope of any claim elements.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than the foregoing description, and all changes that come within the meaning and range of equivalence of the claims are therefore intended to be embraced therein.

1. A metal forged crankshaft comprising a plurality of throws having parallel throw axes lying in a same plane of symmetry and split-lines from the forging process lying in planes substantially orthogonal to said plane of symmetry.

2. The metal forged crankshaft of claim 1, wherein the split-lines of at least two throws lie on different planes.

3. The metal forged crankshaft of claim 2, wherein said plurality of throws includes at least two pairs of throws, the two throws in a pair of throws extending in opposite directions.

4. The metal forged crankshaft of claim 3, wherein, in each pair of throws, the split-line in a throw lies on a different plane with respect to the split-line of the other throw.

5. The metal forged crankshaft of claim 4, wherein said metal is steel.

6. The metal forged crankshaft of claim 4, wherein said metal is iron.

7. An apparatus for metal forging a crankshaft having a plurality of throws having parallel throw axes, the apparatus comprising an upper die and a lower die each having cavities defining a negative imprinted shape of a corresponding half of said crankshaft, the two dies having mating surfaces lying on different parallel planes.

8. The apparatus according to claim 7, wherein said negative imprinted shape defines four throws in said crankshaft.

9. The apparatus according to claim 7, wherein said throws are divided in pairs, the two throws in each pair extending in mutually opposite directions.

10. (canceled)

11. (canceled)

12. A method of metal forging a crankshaft including a plurality of throws having parallel throw axes, comprising the steps of:
heating a rod of metal to make the metal substantially deformable;
positioning the rod of metal between two dies having mating surfaces lying on different parallel planes and shape-defining surfaces that define pairs of throws in said crankshaft extending in mutually opposite directions;
applying forge pressure on said two dies until the respective mating surfaces contact each other.

13. The method according to claim 12, wherein the forging pressure is applied perpendicular to an outer surface of the dies and parallel to the main throws axes of said throws.

14. The method according to claim 13, wherein the mating surfaces are located on different parallel planes.

15. The method according to claim 13, wherein said mating surfaces meet at positions that are substantially proximate to the base of each throw.
